(19) United States
(12) Patent Application Publication
(10) Pub. No.: US 2002/0176571 A1
(43) Pub. Date: Nov. 28, 2002

(54) Multi-function car phone holder

(76) Inventor: Richard Louh, Lung-Tan Hsiang (TW)

Correspondence Address: JACOBSON HOLMAN PLLC, 400 SEVENTH STREET N.W., SUITE 600, WASHINGTON, DC, 20004, US

(21) Appl. No.: 09/861,045

(22) Filed: May 22, 2001

(51) Int. Cl. H04M 1/00

(52) U.S. Cl. 379/455

(57) ABSTRACT

A car phone holder has a base for holding a car phone, a reel and a release mechanism. The base has a seat detachably connected with the base for accommodating mobile phones of different dimensions. The reel is provided in the base for collecting wires of the ear set to prevent the wires from being tangled and the release mechanism is provided to enable the user to easily detach the mobile phone from and attach the mobile phone to the base.

### BACKGROUND OF THE INVENTION

1. Field of the Invention

The present invention relates to a car phone holder with multiple functions, and more particularly to a car phone holder with a reel for collecting the wire of the ear set, a speaker selecting button and a seat for accommodating different types of mobile phones.

2. Description of Related Art

A conventional car phone holder, as shown in FIG. 1, has a seat (1a) and an electrical outlet (2a) that is electrically connected to a car outlet (not shown) for provide electricity to the base (1a). The seat (1a) is pivotally connected with the electrical outlet (2a) so that after the electrical outlet (2a) is electrically connected to the car outlet, the user is able to adjust the orientation of the seat (1a). The seat (1a) further has terminals (3a) electrically connected with the electrical outlet (2a) and a microphone (4a). Therefore, when the mobile phone is seated in the seat (1a), the terminals (3a) is able to charge the mobile phone and the user is able to use the microphone (4a) to talk with the caller directly.

However, this kind of phone holder still suffers from several disadvantages, such as:

1. The seat can only accommodate a certain type of mobile phone, it can not adjust to different types of mobile. Accordingly, when the user changes the type of mobile phone, the user will have to purchase another mobile phone holder, which is quite a waste in money.

2. Although some car phone holder does provide with an ear set, so that the user is able to use the ear set to talk to the caller directly, without using one hand holding the steering wheel and the other holding the mobile phone, the wires of the ear set are exposed outside the holder, which is quite messy and sometimes the wires may get tangled.

3. The attaching and detaching mechanism of the car phone holder is quite complex and complicated, the user often spends a great deal of time attaching or detaching the mobile phone to the seat (1a).

4. The car phone holder can only be used inside the car, it can not be used anywhere outside the car. Therefore, the user will have to buy another set of phone holder for indoor use only.

To overcome the shortcomings, the present invention intends to provide an improved car phone holder to mitigate or obviate the aforementioned problems.

### SUMMARY OF THE INVENTION

The primary objective of the invention is to provide a car phone holder with multiple functions. The car phone holder has a reel to collect the wire of the ear set, a base with a changeable seat for accommodating different types of mobile phones, an ear set selecting button for selection between a speaker and the ear set and a charging button for selecting on/off of the electricity to the mobile phone.

Another objective of the invention is to have a retaining mechanism inside the base to selectively retaining the mobile phone, such that the user is able to easily attach/detach the mobile phone to and from the base.

Still another objective of the invention is to provide a stand for the car phone holder base, such that after the base is detached from the car, the user is still able to use the base to accommodate the mobile phone by the engagement with the stand.

Other objects, advantages and novel features of the invention will become more apparent from the following detailed description when taken in conjunction with the accompanying drawings.

### BRIEF DESCRIPTION OF THE DRAWINGS

FIG. 1 is a perspective view of a conventional car phone holder;

FIG. 2 is a perspective view of a car phone holder constructed in accordance with the present invention;

FIG. 3 is a side view of the car phone holder of FIG. 2;

FIG. 4 is a perspective view of the car phone holder of FIG. 2 with a mobile phone seated inside the seat;

FIG. 5 is a schematic view showing the position of the ear for hanging the ear set;

FIG. 6 is a partially cross sectional view of the ear in connection with the base;

FIG. 7 is an exploded perspective view of the car phone holder of FIG. 2;

FIG. 8 is an exploded view of the car phone holder showing that the seat of the holder is changeable;

FIG. 9 is a plan view showing the retaining mechanism of the car phone holder of the present invention;

FIG. 10 is an enlarged partial cross sectional view showing the retaining mechanism;

FIG. 11 is a plan view showing the releasing of the mobile phone with the retaining mechanism;

FIG. 12 is an enlarged partial cross sectional view showing the movement of the retaining mechanism;

FIG. 13 is an exploded perspective view of the releasing button of the invention;

FIG. 14 is a perspective view showing the engagement between the base and the stand;

FIG. 15 is an exploded perspective view of the stand and the base from another angle;

FIG. 16 is a schematic view showing the engagement between the base and the connection rod;

FIG. 17 is a schematic view showing the engagement between the base and the stand; and

FIG. 18 is a schematic view showing the movement between the base and the stand.

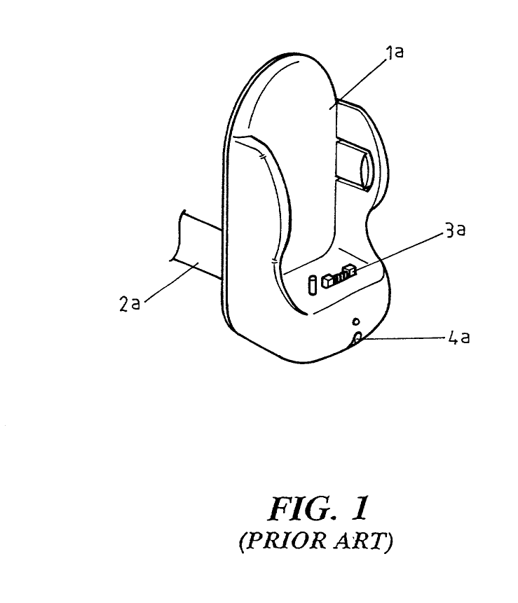

### DETAILED DESCRIPTION OF PREFERRED EMBODIMENT

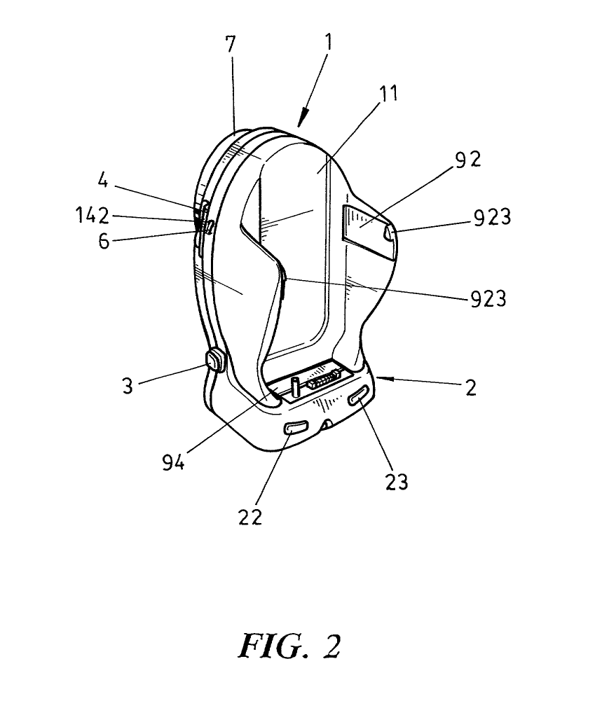

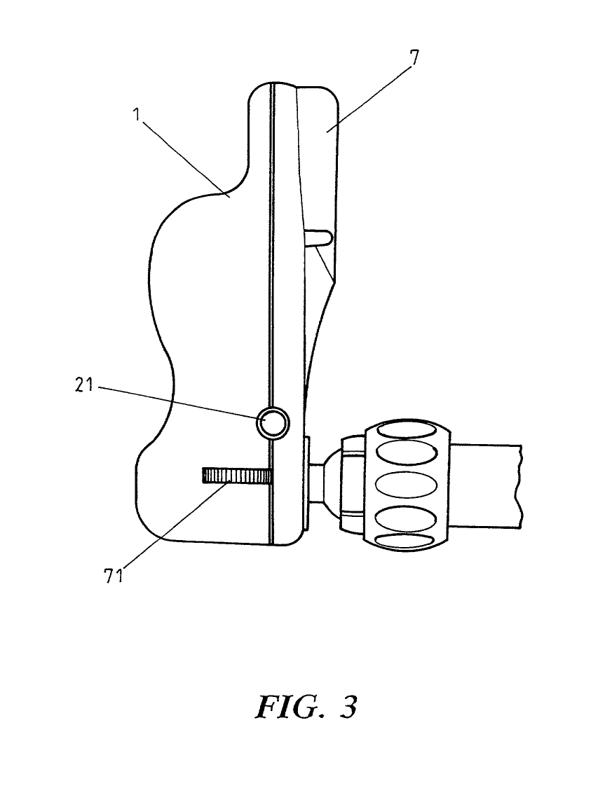

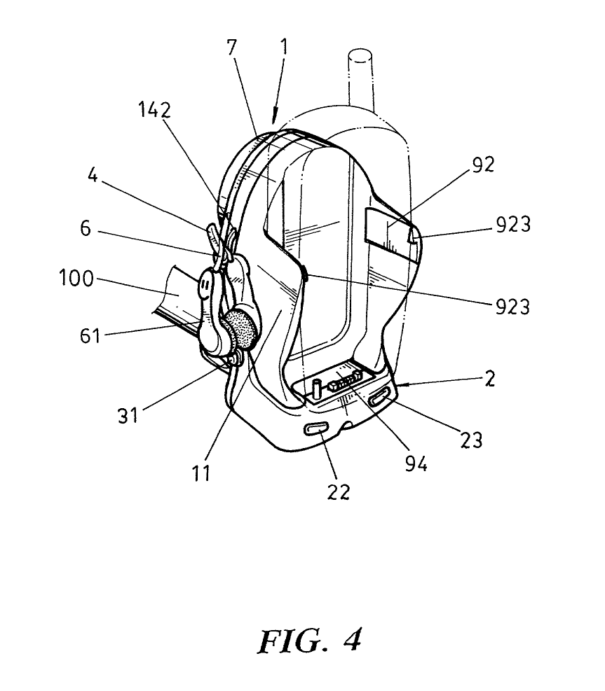

With reference to FIGS. 2 and 4, a multi-function car phone holder in accordance with the present invention has a base (1) for detachably receiving a mobile phone, a charge selecting device (2), an ear set (3) and an ear (4).

The charge selecting device (2) has a charge button (21) provided on a side of the base (1) and above a volume button of a speaker (7), an indicator (22) on the bottom portion of the base (1) and a charge indicator (23). The indicator (22) is provided to show that the car phone holder is electrically connected with an outlet and the charge indicator (23) is provided to show that the battery of the mobile phone is recharged. Before the mobile phone is seated in the base (1), the indicator (22) is lit in red to show that the car phone holder is ready for recharging. After the mobile phone is seated in the base (1), the charge indicator (23) is lit in green to show that the battery of the mobile phone is recharged. When the recharge to the battery is finished or the electricity of the battery is full and a recharge is not necessary, the charge indicator (23) is off if the user chooses to cut off the electricity transmission to the battery by pressing the charge button (21).

The ear set (3) includes a selecting switch (31) for selecting between the speaker (7) and the ear pone (6).

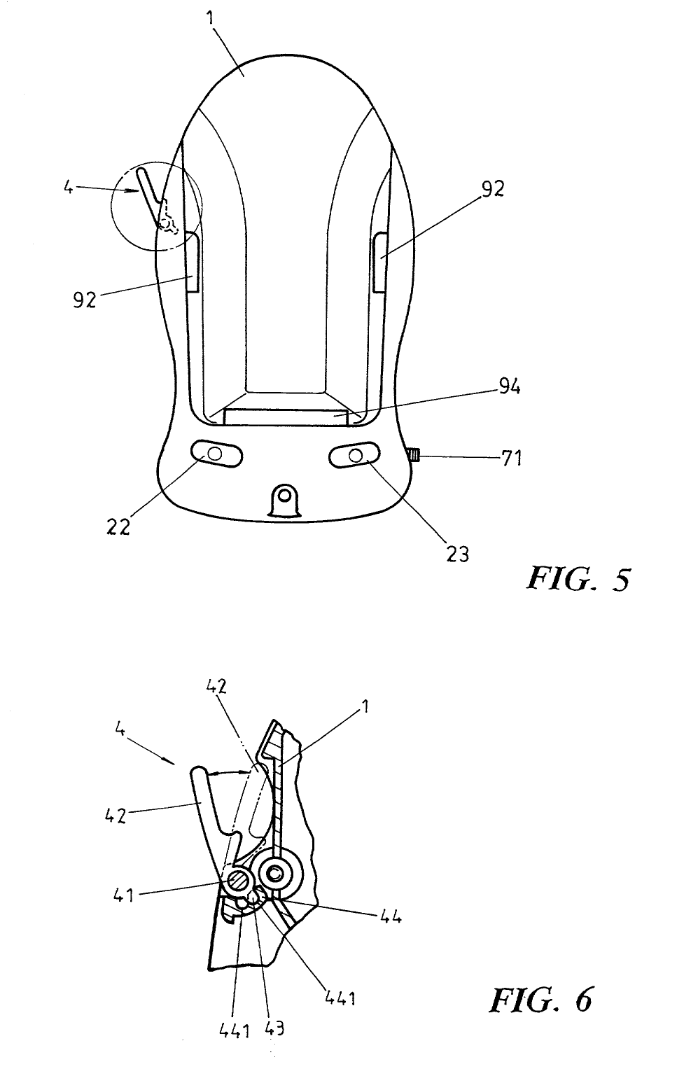

With respect to FIGS. 4 to 6, the ear (4) is pivotal with respect to the base (1) to hang the ear phone (6) on a side of the base (1) and has a shaft (41) securely engaged with the base (1), a hook (42) pivotally engaged with the shaft (41) and having an extension (43) extending out from a bottom of the hook (42) and a retainer (44) for fixing the hook (42). The retainer (44) has a first recess (441) and a second recess (442), such that when the hook (42) pivots in relation to the base (1), the first and second recesses (441,442) are able to fix the hook (42) in an extended mode or a concealed mode. That is, when the hook (42) is in the extended mode, the hook (42) is able to hang the ear phone (6) and when the hook (42) is in the concealed mode, the hook (42) is concealed in the base (1).

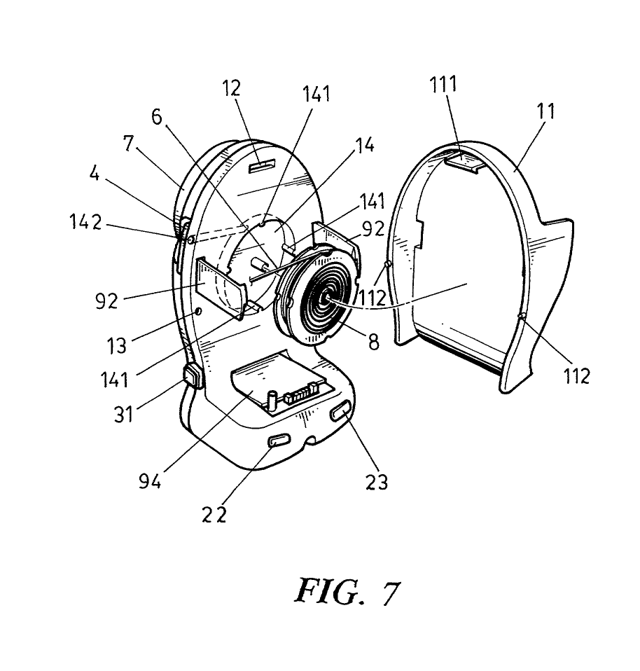

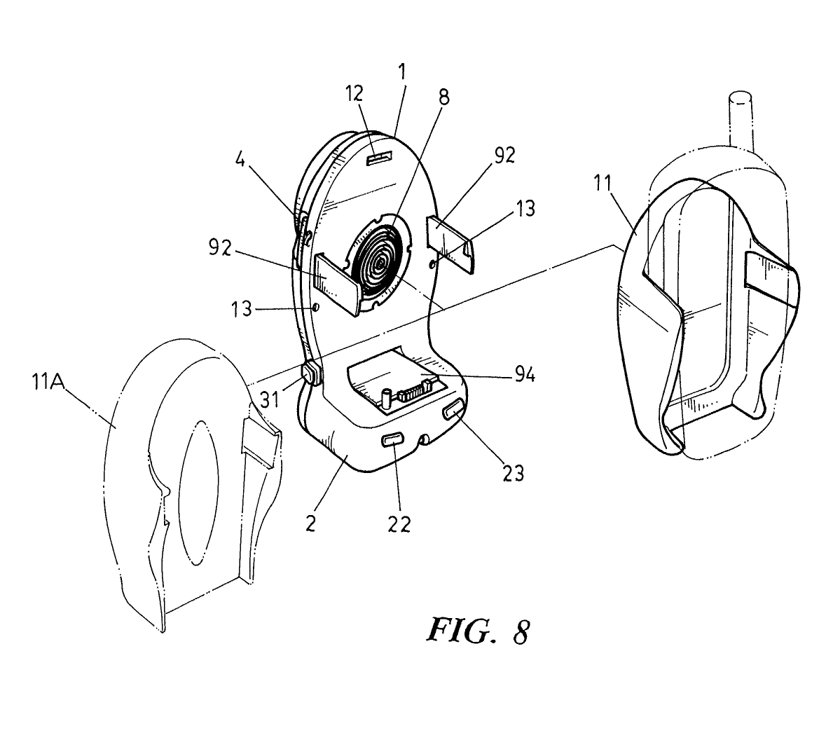

With reference to FIGS. 7 and 8, the base (1) further has a seat (11) detachably connected with the base (1), such that a different seat (11A) is able to attach to the base (1) for accommodating a another different type of mobile phone, such that the user will not have to buy another set of car phone holder only because the user changes the type of mobile phone. The seat (11) has an insert (111) formed on the top of the seat (11) to correspond to a slit (12) in the base (1) and two keys (112) on opposite sides of the seat (11) to correspond to holes (13) in the base (1). Therefore, by inserting the insert (111) into the slit (12) and the keys (112) into the corresponding holes (13), the engagement between the seat (11) and the base (1) is finished. Furthermore, the base (1) has a reel (8) received in a recessed space (14) defined in the base (1) and having ribs (141) formed on an inner periphery of the recessed space (14) to position the reel (8) and an outlet (142) defined to allow the extension of the wire of the ear phone (6). The reel (8) is provided to receive the wire of the ear phone (6) and because the structure of a reel is well known in the art, detailed description thereof is omitted. With such an arrangement, even when the ear phone (6) is being used and the wire is extended out from the reel (8), the wire still not tangle with each other.

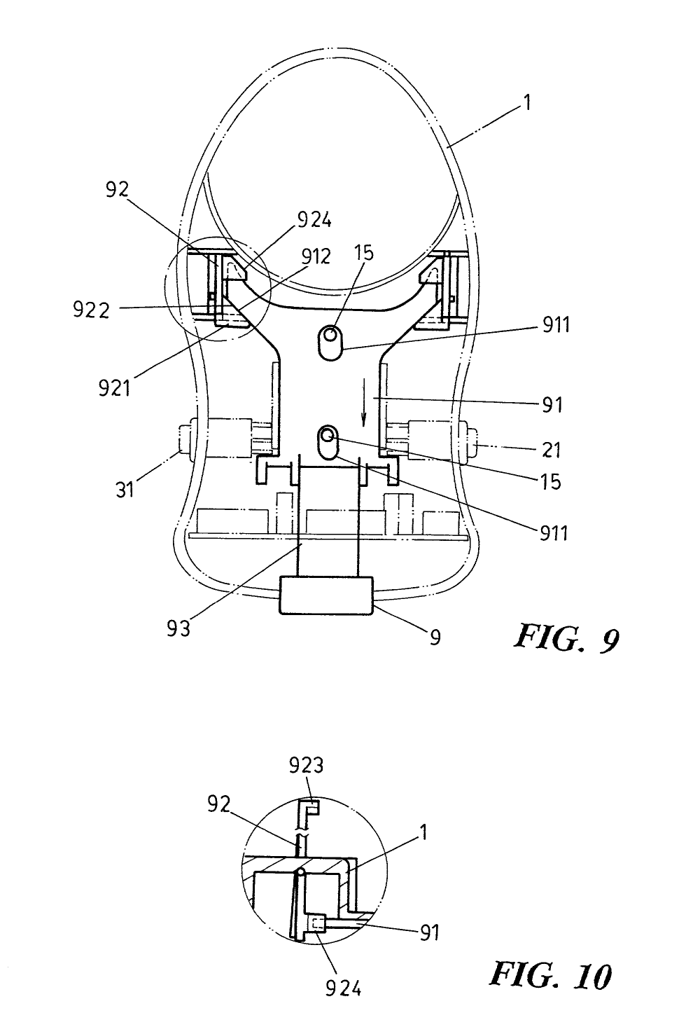

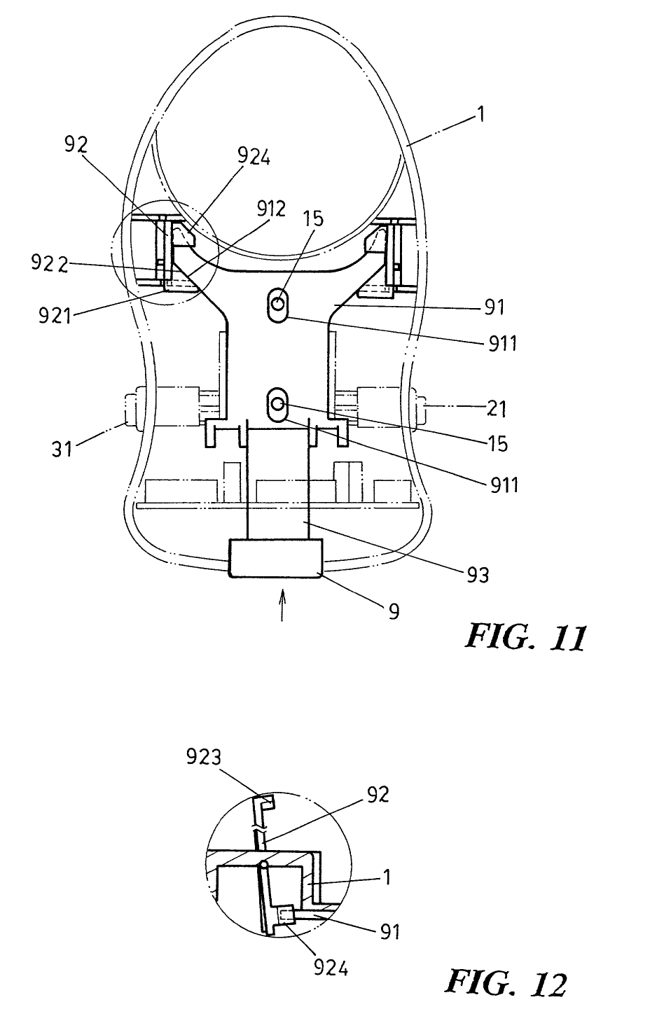

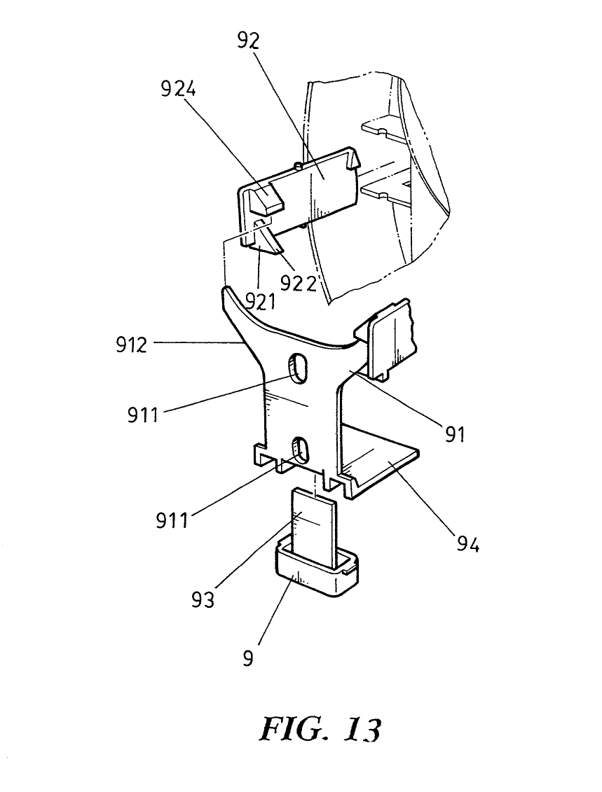

With reference to FIGS. 9 to 13, a release mechanism is provided to the base (1) so that the user is able to easily attach the mobile phone to or release the mobile phone from the base (1). The release mechanism has a release button (9) movably mounted at a bottom of the base (1), a linkage (91) engaged with the release button (9) and having two limit holes (911) corresponding to two limits (15) formed on the base (1), two oppositely formed clamps (92) pivotally mounted on the base (1), and a receiving seat (94) vertically extending out from the linkage (91) for supporting the mobile phone. The linkage (91) has two opposite first inclined sides (912) each formed to correspond to one of oppositely formed second inclined sides (922) of the clamps (92). The clamp (92) has a sliding block (921) movably mounted on the base (1) along a predetermined path, such that when the linkage (91) moves upward respective to the base (1), due to the engagement between the first and second inclined sides (912,922), the clamps (92) move away from each other. That is, when the user is about to release the mobile phone secure by the clamps (92), the user pushes the release button (9) to drive the movement of the clamps (92), which frees the secure to the mobile phone. The clamp (92) further has a cap (934) securely mounted on top of the sliding block (921) for enclosing tips of the linkage (91). However, when the mobile phone is seated in the receiving seat (94), the weight of the mobile phone forces the linkage (91) to move downward with respect to the base (1), which also forces the clamps (92) to pivot by means of two bosses (920) oppositely formed on each of the clamps (92) and pivotally received in two pivot holes (10) in the base (1). When the clamps (92) move toward each other, clamping plates (923) integrally formed on the front of the clamps (92) are able to secure the mobile phone in the receiving seat (94).

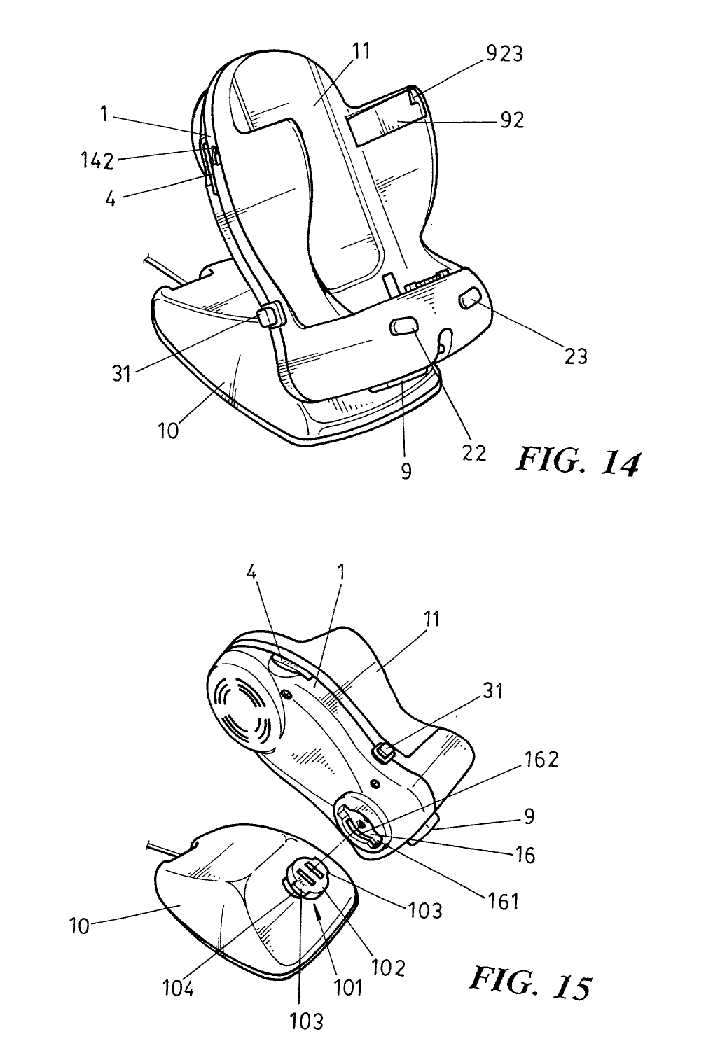

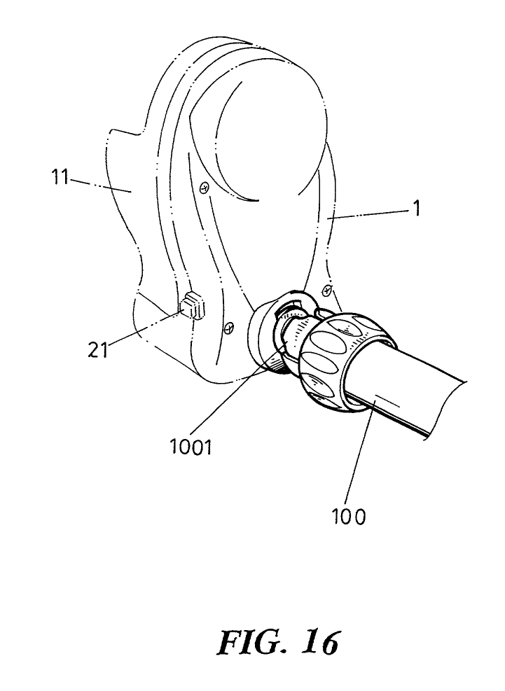

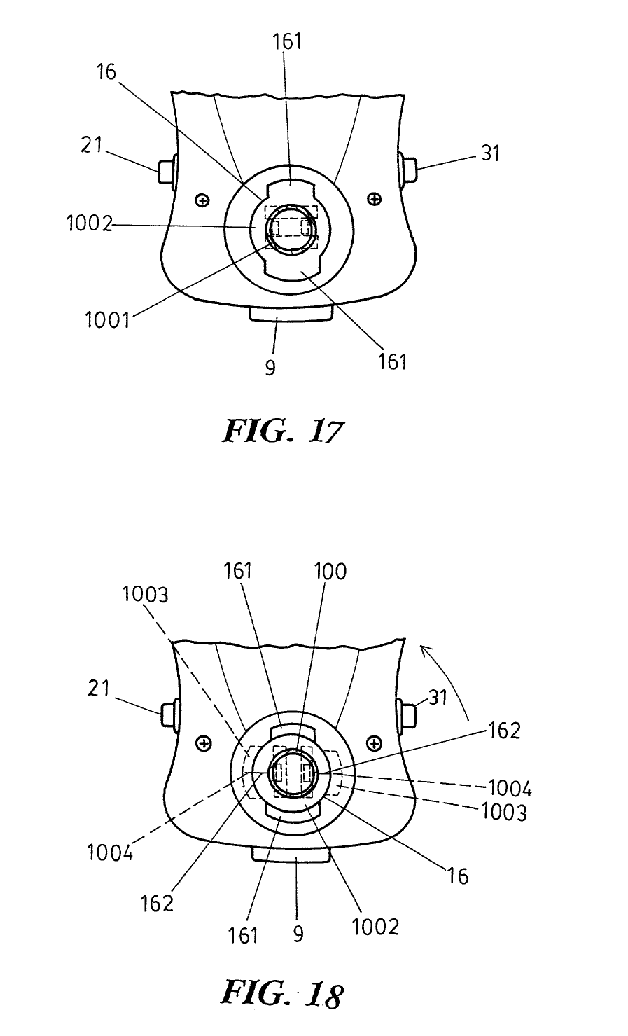

With reference to FIGS. 14 and 15 to 18, the multi-function car phone holder further has a stand (10) for positioning the base (10) indoors and a connection rod (100) configured to be connected with the electrical outlet on the car and to provide electricity to the base (1). In order to connect with either the stand (10) or the connection rod (100), a blind hole (16) is defined in the back of the base (1). A connector (1001,101) of the connection rod (100) and the stand (10) has the same structure and thus the structure of both the connector (101) of the stand (10) and the connector (1001) of the connection rod (100) are introduced simultaneously.

The blind hole (16) has a first notch (161) and a second notch (162) both defined in a periphery defining the blind hole (16) and the dimension of the first notch (161) is not the same as the dimension of the second notch (162). To correspond to the blind hole (16), the connector (1001,101) of the connection rod (100) and the stand (10) has a head (1002,102) with dimension slightly smaller than the dimension of the blind hole (16), such that the head (1002,102) is able to be received in the blind hole (16). The head (1002,102) further has a first block (1003,103) and a second block (1004,104) respectively corresponding to the first and second notches (161,162) of the blind hole (16). Therefore, before the head (1002,102) is seated in the blind hole (16), only a specific orientation of the head (1002,102) is allowed to be seated in the blind hole (16) to have the correct electric connection. To further secure the engagement, the blind hole (16) defines a tapered path (163) communicating with both the first and second notches (161,162), such that after the head (1002,102) is seated in the blind hole (16), rotating the head (1002,102) will allow the first and second blocks (1003,1004; 103,104) to be secured in the tapered path (163), which provides a secure engagement between the base (1) and the stand (10) or the connection rod (100).

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A car phone holder comprising:
a base for holding a mobile phone therein;
a seat detachably connected to the base for holding mobile phones of different dimensions;
a charge selecting device mounted on a front side of the base and having an indicator for indicating electricity status of the car phone holder and an charging indicator for indicating charging status of battery of a mobile phone;
an ear set provided to a side of the base and having a selecting switch for selecting between an ear phone and a speaker;
an ear pivotally engaged with a top side of the base for hanging wire of the ear set;
a reel received in a recessed space in the base for collecting wire of the ear set and
a release mechanism having
a release button movably mounted at a bottom of the base;
a linkage engaged with the release button and having two limit holes corresponding to two limits formed on the base;
two oppositely formed clamps pivotally mounted on the base and each having a cap securely mounted on top of the clamp for enclosing tip of the linkage; and
a receiving seat vertically extending out from the linkage for supporting the mobile phone,
wherein the linkage further has two opposite first inclined sides each formed to correspond to one of oppositely formed second inclined sides of the clamps so that movement of the linkage drives the clamps to move.

2. The holder as claimed in claim 1, wherein the clamp further has a sliding block movably mounted on the base along a predetermined path, such that when the linkage moves in a first mode, due to the engagement between the first and second inclined sides, the clamps move away from each other.

3. The holder as claimed in claim 1, wherein the ear has a shaft securely engaged with the base, a hook pivotally engaged with the shaft and having an extension extending out from a bottom of the hook and a retainer for positioning the hook and the retainer having a first recess and a second recess, such that when the hook pivots in relation to the base, the first and second recesses are able to fix the extension of the hook in an extended mode or a concealed mode.

4. The holder as claimed in claim 2, wherein the ear has a shaft securely engaged with the base, a hook pivotally engaged with the shaft and having an extension extending out from a bottom of the hook and a retainer for positioning the hook and the retainer having a first recess and a second recess, such that when the hook pivots in relation to the base, the first and second recesses are able to fix the extension of the hook in an extended mode or a concealed mode.

5. The holder as claimed in claim 1 further has a stand for indoor use of the base and the stand having a connector to be electrically connected with the base.

6. The holder as claimed in claim 2 further has a stand for indoor use of the base and the stand having a connector to be electrically connected with the base.

7. The holder as claimed in claim 3 further has a stand for indoor use of the base and the stand having a connector to be electrically connected with the base.

8. The holder as claimed in claim 4 further has a stand for indoor use of the base and the stand having a connector to be electrically connected with the base.

9. The holder as claimed in claim 1, wherein the seat has an insert mounted on top of the seat to correspond to a slit defined in the base and two oppositely formed keys to correspond to two holes in the base.

10. The holder as claimed in claim 1, the recessed space further has ribs formed on a side pace defining the recessed space to position the reel.

11. A car phone holder comprising:
a base for holding a mobile phone therein;
a seat detachably connected to the base for holding mobile phones of different dimensions;
a charge selecting device mounted on a front side of the base and having an indicator for indicating electricity status of the car phone holder and an charging indicator for indicating charging status of battery of a mobile phone;
an ear set provided to a side of the base and having a selecting switch for selecting between an ear phone and a speaker;
an ear pivotally engaged with a top side of the base for hanging wire of the ear set and having a shaft securely engaged with the base, a hook pivotally engaged with the shaft and having an extension extending out from a bottom of the hook and a retainer for positioning the hook and the retainer having a first recess and a second recess, such that when the hook pivots in relation to the base, the first and second recesses are able to fix the extension of the hook in an extended mode or a concealed mode;
a reel received in a recessed space in the base for collecting wire of the ear set and
a release mechanism having
a release button movably mounted at a bottom of the base;
a linkage engaged with the release button and having two limit holes corresponding to two limits formed on the base;
two oppositely formed clamps pivotally mounted on the base and each having a cap securely mounted on top of the clamp for enclosing tip of the linkage; and
a receiving seat vertically extending out from the linkage for supporting the mobile phone,
wherein the linkage further has two opposite first inclined sides each formed to correspond to one of oppositely formed second inclined sides of the clamps so that movement of the linkage drives the clamps to move.

12. The holder as claimed in claim 11 further has a stand for indoor use of the base and the stand having a connector to be electrically connected with the base.

13. The holder as claimed in claim 11, wherein the seat has an insert mounted on top of the seat to correspond to a slit defined in the base and two oppositely formed keys to correspond to two holes in the base.

14. The holder as claimed in claim 11, the recessed space further has ribs formed on a side pace defining the recessed space to position the reel.

15. The holder as claimed in claim 12, the recessed space further has ribs formed on a side pace defining the recessed space to position the reel.

16. The holder as claimed in claim 13, the recessed space further has ribs formed on a side pace defining the recessed space to position the reel.
